(19) United States
(12) Patent Application Publication
(10) Pub. No.: US 2026/0200362 A1
(43) Pub. Date: Jul. 16, 2026

(54) SYSTEMS AND CIRCUITS FOR PERFORMING DYNAMIC LOAD MANAGEMENT FOR ELECTRIC VEHICLE CHARGING AND METHODS OF OPERATING THE SAME

(71) Applicant: GOPOWEREV INC., Palo Alto, CA (US)

(72) Inventors: John Reister, Palo Alto, CA (US); Harrison Waschura, Los Altos Hills, CA (US); Daniel Knittle, Reno, NV (US); Christopher Grill, Monroeville, PA (US)

(21) Appl. No.: 19/451,594

(22) Filed: Jan. 16, 2026

Related U.S. Application Data
(60) Provisional application No. 63/745,997, filed on Jan. 16, 2025.

(51) Int. Cl. B60L 53/62; B60L 53/64

(52) U.S. Cl. CPC B60L 53/62; B60L 53/64

(57) ABSTRACT

A dynamic load management system for charging electric devices is provided. The system includes one or more smart outlets including one or more charging ports therein; a local control unit (LCU) coupled to the one or more smart outlets that includes a charging manager and receives stored data, monitored data and user input, wherein the charging manager processes the received stored data, monitored data and user input to generate a control command that is used to energize a charging port of the one or more charging ports or to change energy flow of a session; and an automatic load management (ALM) module in communication with the LCU and the one or more smart outlets, the ALM receiving real-time load data and load requests from the charging manager and providing a status to the charging manager to enable dynamic allocation of resources to the one or more smart outlets. The one or more smart outlets include a hardware safety switch that energizes or deenergizes responsive to signals from the LCU and/or the ALM. The one or more smart outlets can reduce or increase the energy flow based on commands from the LCU

### CLAIM OF PRIORITY

The present application claims the benefit of and priority to U.S. Provisional Application No. 63/745,997, filed on Jan. 16, 2025, entitled Systems and Circuits Configured to Perform Dynamic Load Management for Electric Vehicle Charging and Methods of Operating the Same, the contents of which are hereby incorporated herein by reference as if set forth in its entirety.

### FIELD

The present inventive concept relates generally to electric vehicles and, more particularly to load management when charging electric vehicles.

### BACKGROUND

Automatic Load Management (ALM) for EVs can face a variety of challenges. For example, an equipment supplier, installer, and operator of EV charging systems and other distributed energy resources (DER), may suffer delays in an EV charger installation due to Utility engineering, infrastructure upgrades, and Authority Having Jurisdiction permitting processes. In some present cases, 56% of EV installations have been delayed due to transformer upgrade requirements. On average, these delays may be as long as 8-24 months.

### SUMMARY

Some embodiments of the present inventive concept provide a dynamic load management system for charging electric devices. The system includes one or more smart outlets including one or more charging ports therein; a local control unit (LCU) coupled to the one or more smart outlets that includes a charging manager and receives stored data, monitored data and user input, wherein the charging manager processes the received stored data, monitored data and user input to generate a control command that is used to energize a charging port of the one or more charging ports or to change energy flow of a session; and an automatic load management (ALM) module in communication with the LCU and the one or more smart outlets, the ALM receiving real-time load data and load requests from the charging manager and providing a status to the charging manager to enable dynamic allocation of resources to the one or more smart outlets. The one or more smart outlets include a hardware safety switch that energizes or deenergizes responsive to signals from the LCU and/or the ALM.

In further embodiments, the one or more smart outlets may further include metrology and sensors that measure current flow through an associated charging port and provide load data and sensor readings to the charging manager; and a session controller that energizes and de-energizes charging ports responsive to the control command.

In still further embodiments, the one or more smart outlets may shed load such that current may be apportioned at intervals between a fully off state and a fully on state by reducing current allocation without fully de-energizing a charging port.

In some embodiments, the ALM may be one of separate and distinct from the LCU and integrated with the LCU into a single device.

In further embodiments, the electric device may be an electric vehicle.

In still further embodiments, the system may further include at least one external power monitor configured to measure a load on at least one of a distribution transformer, switchgear, panel, or feeder and provide the measured load to the LCU for use in allocating resources to the one or more smart outlets.

In some embodiments, the ALM may further receives real-time load measurements from the at least one external power monitor and from the smart outlets, determines whether a proposed charging state satisfies all hierarchical limits, transmits energize and de-energize permissions to the smart outlets, and periodically transmits keep-alive authorization messages to the one or more smart outlets such that failure to receive the keep-alive authorization causes the smart outlet to automatically de-energize the one or more charging ports.

In further embodiments, the ALM may permits bi-directional power flow from the electric device while ensuring reverse aggregate current does not exceed a predetermined threshold.

In still further embodiments, the hardware safety switch may immediately open when a measured current exceeds a kill threshold independent of software execution.

In some embodiments, a distribution transformer monitor may be mounted to a utility transformer and streaming load data to the ALM.

In further embodiments, load limits may be enforced at property, building, and sub-panel hierarchy levels.

In still further embodiments, current may be adjusted based on utility pricing and environmental conditions.

In some embodiments, the one or more smart outlets may reduce or increase energy flow in response to control commands from the LCU.

Further embodiments of the present inventive concept provide methods of dynamically managing electric vehicle charging loads. The method includes receiving a charging session request for at least one charging port; receiving real-time electrical load measurements from at least one external power monitor and from one or more smart outlets; evaluating a system topology file defining hierarchical static and dynamic load limits for electrical infrastructure nodes; determining whether the charging session request satisfies all load limits defined in the topology file; transmitting an energize command and a kill threshold to one or more smart outlets when the charging session request is safe; periodically transmitting keep-alive messages to the one or more smart outlets; and causing the smart outlet to de-energize the at least one charging port when the keep-alive messages are not received within a predetermined time interval.

In still further embodiments, the method may further include forecasting future load using historical session data and user departure times.

In some embodiments, the method may further include dynamically reducing current to an active session when external loads increase.

In some embodiments, the method may further include reverting to a predefined static safe load when real-time monitoring data becomes unavailable.

In further embodiments, the method may further include generating a dashboard showing current and forecasted transformer loading.

Still further embodiments of the present inventive concept provide non-transitory computer-readable mediums storing instructions for dynamically managing electrical vehicle charging loads that, when executed by one or more processors, cause the processors to receive a charging session request for at least one charging port; receive real-time electrical load measurements from at least one external power monitor and from one or more smart outlets; evaluate a system topology file defining hierarchical static and dynamic load limits for electrical infrastructure nodes; determine whether the charging session request satisfies all load limits defined in the topology file; transmit an energize command and a kill threshold to one or more smart outlets when the charging session request is safe; periodically transmit keep-alive messages to the one or more smart outlets; and cause the smart outlet to de-energize the at least one charging port when the keep-alive messages are not received within a predetermined time interval.

In some embodiments, the instructions may further dynamically reduce current to an active session when external loads increase.

### BRIEF DESCRIPTION OF THE DRAWINGS

FIG. 1 is a block diagram illustrating a charging system including an automatic load management (ALM) module incorporated into a local control gateway (LCU) in accordance with some embodiments of the present inventive concept.

FIG. 2 is a block diagram illustrating a charging system including an ALM module that is separate and distinct from an LCU in accordance with some embodiments of the present inventive concept.

FIG. 3 is a block diagram illustrating a hand drawn electrical topology for an ALM module according to some embodiments of the present inventive concept.

FIG. 4. is a block diagram illustrating an electrical topology for an ALM module according to some embodiments of the present inventive concept.

FIGS. 5A through 5C are graphs illustrating ALM Dynamic Load Metering for an ALM module according to some embodiments of the present inventive concept.

FIG. 6 is a block diagram of a system including a distribution transformer module (DTM) according to some embodiments of the present inventive concept.

FIG. 7 is a block diagram illustrating a data processor suitable for use in accordance with some embodiments of the present inventive concept.

### DETAILED DESCRIPTION

The inventive concept now will be described more fully hereinafter with reference to the accompanying drawings, in which illustrative embodiments of the inventive concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout. As used herein, the term “and/or” includes any and all combinations of one or more of the associated listed items. Similarly, as used herein, the word “or” is intended to cover inclusive and exclusive OR conditions. In other words, A or B or C includes any or all of the following alternative combinations as appropriate for a particular usage: An alone; B alone; C alone; A and B only; A and C only; B and C only; and A and B and C.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Reference will now be made in detail in various and alternative example embodiments and to the accompanying figures. Each example embodiment is provided by way of explanation, and not as a limitation. It will be apparent to those skilled in the art that modifications and variations can be made without departing from the scope or spirit of the disclosure and claims. For instance, features illustrated or described as part of one embodiment may be used in connection with another embodiment to yield a still further embodiment. Thus, it is intended that the present disclosure includes modifications and variations that come within the scope of the appended claims and their Equivalents.

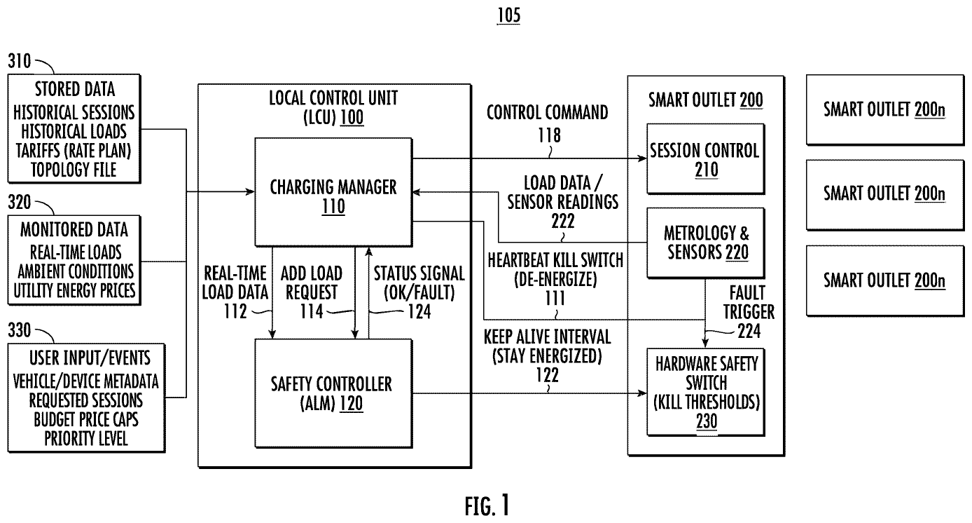

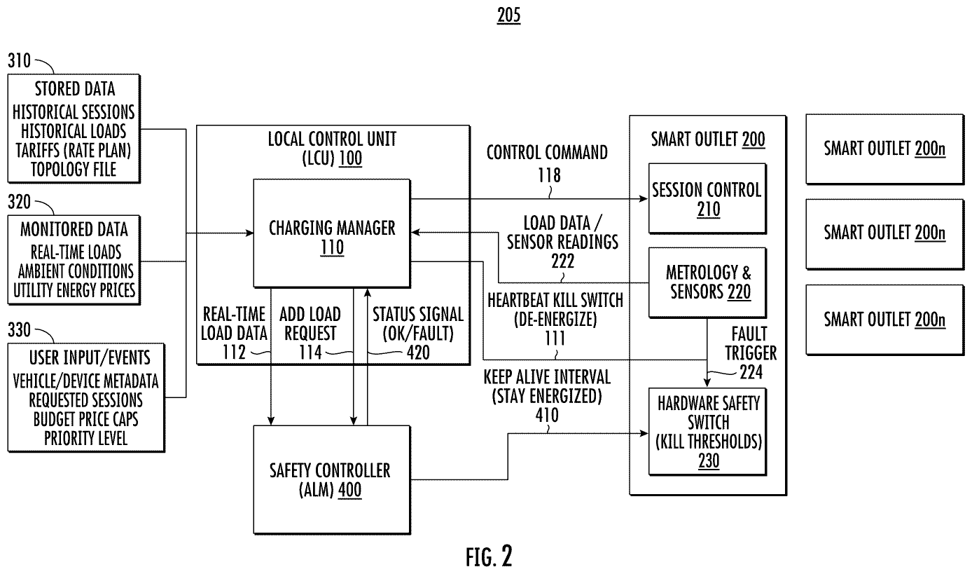

As used herein, “electric vehicle infrastructure (EVI)” refers to the EVI solution, as illustrated in, for example, FIGS. 1-2, along with the EV supply utility panel, circuit breakers, and dedicated or shared electric circuits that run from the supply panel to the SmartOutlets. Similarly, “EVI ports” refer to any electric port that an EV can be plugged into. Further, “100 Amperes of EVI” refers to an EVI where the aggregate of the ports is 100 Amperes. It will be understood that the term “Session” or “EV Energy Session” or “EVES” refers to a period of time when an EV is connected to a port, during which energy may be commanded to flow to or from the EV and the power may vary during the course of the session.

As used herein, a “SmartOutlet” can refer to any outlet that enabled embodiments of the present inventive concept. For example, in some embodiments a SmartOutlet may be national electrical manufacturers association (NEMA) receptacles. A NEMA receptacle is a standardized electrical receptacle in North America, featuring unique pin configurations (shapes/sizes) for specific voltages (e.g., 120V, 240V) and amperage (15 A, 30 A, 50 A) to ensure safety and compatibility, with the common household outlet being a NEMA 5-15, while larger ones like NEMA 14-50 are for appliances like stoves or EV chargers. These configurations may prevent plugging incompatible devices into outlets, using different blade shapes and orientations for different power needs. However, in further embodiments, there may be a different type of port that provides a more generical connector port. Any “connector” for the SmartOutlet may be used without departing from the scope of the present inventive concept.

Furthermore, in some embodiments of the present inventive concept SmartOutlet can adjust the load up or down. For example, instead of an on/off state, SmartOutlets discussed herein can “shed-load” by dropping or increasing the number of amperes delivered between the on and off states. For example, the system may drop from charging at 16 Amperes to 5 Amperes, as opposed to turning it off entirely. In other words, embodiments discussed herein can “shed load” when necessary. Furthermore, some embodiments of the present inventive concept can allow the current to flow backwards. For example, if batteries are used in the EVs to send power back through the meters, the ALM in accordance with embodiments discussed herein ensures that the aggregate power that is being sent backwards will not exceed constraints as will be discussed further herein.

Although systems are discussed herein as being utilized with EVs, embodiments of the present inventive concept are not limited thereto. Dynamic charging systems discussed herein may be used to charge any unit that requires charging without departing from the scope of the present inventive concept.

As discussed above, Electric Vehicle (EV) charging infrastructure and associated installation services and ongoing services face a variety of challenges, which more advanced Automatic Load Management (ALM) can solve or mitigate. For example, an equipment supplier, installer, or operator of EV charging systems and other distributed energy resources (DER) resources, may suffer delays in EV energy infrastructure installation due to, for example, utility engineering, utility or building infrastructure upgrades, and authority having jurisdiction permitting processes. In some present cases, fifty-six (56) percent (%) of EV installations have been delayed due to transformer upgrade requirements. On average, these delays may be as long as 8-24 months. Once installed, drivers at a location are sharing an energy supply and may desire to have sufficient energy in their batteries by their intended departure times. The same drivers may wish to export energy if they can make a profit doing so. Utilities can plan their energy supply and generation if they can anticipate and forecast energy flows in the near-term. Accordingly, some embodiments of the present inventive concept provide for dynamic load management for EV charging that address some of the shortcomings of conventional charging systems as will be discussed further herein.

An ALM system may operate in various modes/scenarios. For example, an ALM system may provide a “static load” limit that is enforced on the demand system, i.e. the load set one time based on the design of the electrical system design. In other embodiments, the ALM may provide a dynamic system that is updated based on “real-time” bi-directional loads experienced by the electrical system. In these embodiments, various parameters are monitored, such as transformers, main service, meters, and/or panels. Then, the loads are dynamically adjusted based on the desired goals of the unit being charged. Still further embodiments may generate energy using, example, solar photovoltaic (PV) or battery storage.

In particular, with respect to a static limit, due to NEC code, a 400 A panel is, for example, limited to 200 A main breaker, but 400 A worth of EV circuits are installed on the panel. ALM limits the simultaneous energy flow to <200 A (* 80% continuous limit). In these embodiments, the panel limit to 200 A may be due to, for example, upstream busbar, switchgear, or transformer limits. If a generator is installed on the panel, ALM allows for generation that prevents the main breaker from tripping and prevents the overload of the panel bussing, while allowing for more than 200 A of charging.

With respect to a dynamic limit, a transformer's load may be the limiting factor in an installation; it has headroom (e.g.) for 100 A of EV ports to be installed based on Utility calculations. Feeder and switchgear have ample headroom for the 500 A worth of ports wanting to be installed. A Distribution Transformer Monitor may be installed on the transformer to monitor its real-time load. That real-time load is an input to the ALM and reduces the likelihood that the transformer will exceed its rating.

The main property breaker (i.e., main switchgear) may be a limiting factor in an installation; it is rated (e.g.) for 2000 A and a load study of peak demand has shown that only 100 A of EVI can be installed. The upstream transformer has ample headroom for the 500 A chargers wanting to be installed. A real-time power monitor may be installed on the switchgear conductors. That real-time load is used as an input to the ALM and is used to ensure the switchgear never exceeds its rating.

Both the transformer and property main breaker are undersized for the additional 500 A of EVI to be installed. Real-time monitoring equipment may be installed for the transformer and on the switchgear. The ALM uses these inputs to ensure neither the transformer nor the switchgear is ever overloaded.

If the system accommodates energy generation, the ALM may allow for and ensure generation supports additional EV charging load without exceeding any gear rating.

In all embodiments, without ALM the full installation would be delayed until the limiting infrastructure can be upgraded. In some embodiments, an initial installation could be completed with the existing headroom, but without an ALM that would only allow for energization of a small subset of EVI ports. Details with respect ALMs in accordance with embodiments discussed herein will be discussed further with respect to the figures.

Referring first to FIG. 1, a block diagram illustrating a charging system including an ALM 120 in accordance with some embodiments of the present inventive concept will be discussed. As illustrated in FIG. 1, the system 105 includes a local control unit (LCU) 100, a plurality of SmartOutlets 200-200n. In embodiments illustrated in FIG. 1, the LCU includes a charging manager 110 and an ALM 120 (safety controller). It will be understood that although the ALM 120 is shown as being inside LCU 100 in embodiments illustrated in FIG. 1, embodiments are not limited thereto. In some embodiments, the ALM 120 may be separate and distinct from the LCU 100 without departing from the scope of the present inventive concept. Such embodiments are illustrated in, for example, FIG. 2, and will be discussed further below.

As further illustrated in FIG. 1, the LCU 100 receives stored data 310 (e.g. topology file, historical sessions,, tariffs and the like); monitored data 320 (e.g. real-time loads,, ambient conditions, utility energy prices and the like); and user input 330 (vehicle/unit/device metadata, requested sessions, budget price caps, priority level and the like). It will be understood that the types of data provide as examples of stored data, monitored data and user input are provided as examples only and embodiments of the present inventive concept are not limited thereto. Thus, any stored data, monitored data and/or user input may be used without departing from the scope of the present inventive concept.

As further illustrated in FIG. 1, the charging manager 110 receives the various data 310, 320 and 330 and communicates with the ALM 120 (real-time load data 112 or additional load requests 114) and the ALM 120 provides a status signal 124 back to the charging manager 110.

As illustrated, the SmartOutlet 200 includes a session controller 210, metrology and sensors 220 and a hardware safety switch 230. It will be understood that the SmartOutlet 200 is provided as an example only and embodiments are not limited to the elements thereof. More or less elements may be provided in the SmartOutlet 200 without departing from the scope of the inventive concept. Furthermore, the physical outlet/plug/connector can have any form and is not limited to a specific form factor.

The charging manager 110 communicates a control command 118 to the session controller 210 and receives load data and sensor readings 222 therefrom. The hardware safety switch 230 receives a fault trigger 224 from the metrology and sensors 220, a heartbeat kill switch (de-energize) 111 from the charging manager 110 and/or a keep alive interval (stay energized) 122 from the ALM 120.

In embodiments of the present inventive concept illustrated in FIG. 1, the charging manager 110 and ALM 120 are subsystems within the LCU 100 and Smart Outlet 200 that performs safety checking to allow additional load or enacts emergency load shedding. As discussed above, In some embodiments, the ALM 120 may be a separate device connected to the LCU 100 with, for example, a low-latency networking mechanism that allows real-time query and response which will be discussed further with respect to FIG. 2.

In particular, in operation as illustrated in FIG. 1, the charging manager 110 receives (or is passed) inputs that may include, for example, knowledge inputs (310 Stored Data), state inputs (320 Monitored Data), request inputs (330 User Input/Events) and the like. Knowledge inputs may include, for example, system topology and fixed load limits, historical external load information, historical EVI loads, and/or tariff information (electricity pricing plans, projected over time). State inputs may include, for example, current system loads provided, for example, via SmartOutlet Operstatus; current externally measured loads (320), for example, via power monitors, DTMs; current external EVI-controlled generated flows (solar/battery), real-time electricity prices, and/or current external utility power data, for example, via application programming interface (API) (substation load limits). Request inputs (330) may include, for example, proposed loads, such as requests for new energy flows.

The charging manager 110 provides the system topology inputs and state inputs (112) to the ALM 120. In some embodiments, the charging manager 110 validates and prioritizes the request inputs based on, for example, state and knowledge inputs, and provides the request inputs to the ALM via an additional load request 114. The ALM 120 may determine whether a proposed set of loads provides a “safe operating condition,” in view of the inputs, for example, system topology, load limits, and the current state of electricity flows.

For static threshold systems discussed above, the safety of the operating condition may only need to be answered at session state transitions. In dynamic threshold systems, the safety operating condition may also be answered at session state transitions. However, it may also be addressed on an ongoing basis. In this embodiments, the ALM 120 ensures that current EVI session loads, externally measured loads, external EVI-controlled generated flows, and external utility data are actually “current,” and failsafe to a low-load condition (e.g. revert to the guaranteed safe static limit) if those sensors fail to send timely data. In FIG. 1, this function is performed by heartbeat kill switch 111 and keep alive intervals 122. The ALM module 120 (safety controller) uses the input data to assess the safety and provide signals to the hardware safety switch.

In dynamic threshold systems, if the ALM 120 denies an add load request 114, the Charging Manager 110 may choose to send a Control Command 118 to ask the SmartOutlet 200 to reduce the power level of a different existing session and adjust the fault trigger on that existing session. This change will provide more headroom for further Add Load Requests. The Charger Manager 110 may subsequently retry a previously rejected Add Load Request.

In operation, if it is determined that the new proposed session is not safe and the current state is still safe, no additional ports will be energized and the unsafe request is reported to the entity that suggested the new proposed session. If it is determined that the current state is no longer safe, a de-energize command is sent to the SmartOutlet(s) (Sos) and the un-safe failure is reported to whatever entity suggested the load profile.

If proposed state is safe, energize commands are sent to the appropriate SmartOutlets that include, for example, permission to energize for new sessions; permission to stay energized for existing sessions; a safety kill threshold; and an alarm threshold. Then the success is reported to whatever suggested the load profile. In some embodiments, the power meter or DTM may be configured to assert interrupts/alarms when thresholds are crossed. Embodiments having this functionality could reduce the need for polling the sensor but may still include some failsafe watchdog.

It will be understood that SmartOutlet 200 may contain one or more ports as discussed above. In some embodiments, the SmartOutlet 200 may be a female receptacle that may accept, for example, NEMA, Type2 or NACS connectors. However, embodiments are not limited thereto.

In some embodiments, the SmartOutlet may also play a role in the ALM system 105. The SmartOutlet 200 may energizes ports if the ALM module 120 has determined it is safe to do so. In these embodiments, the ALM module 120 may ensure that the SmartOutlet will not energize a port without a command to do so. If the current state is no longer safe, the SmartOutlet will shed load to make the state safe. A command 118 from the charging monitor 110 to energize a port or to change the energy flow of a Session can be sent if permitted by the ALM module 120.

In further embodiments, if a non-certified software is in charge of sending the energize commands to an SmartOutlet 200 after checking with the ALM module 120, that software may fail and still communicate the energize command even though it wasn't supposed to. Therefore, in these embodiments, the sending of energize commands are a certified function. In some embodiments, only the ALM module 120 can send energize commands. Thus, other SmartOutlet-LCU messages would still go to the LCU service, but this critical message would only come from the ALM. In further embodiments, the LCU service may send energize commands, but will also send some verification code in the message, which is generated by the ALM module, which the SmartOutlet will use to verify the safe ALM state.

In operation, when a SmartOutlet 200 receives an energize command, it sets and verifies a kill threshold. The kill threshold generally corresponds to the amperage that was allocated to the port. If the port draws more than the allocated current as measured by, for example, the metrology 220, the interrupt will immediately cause the port to de-energize. This kill limit function, once set by the firmware, may be carried out the hardware safety switch 230, via, for example, discrete logic and relay drivers.

Once the kill threshold is set and verified, the SmartOutlet 200 energizes the receptacle. The session is carried out, with reporting to the LCU 100 including operstatus, energy measurements, and the like. If the port load exceeds the alarm threshold, the SmartOutlet 200 sends a message to the LCU 100. If the SmartOutlet 200 receives a de-energize command, the Session State Logic 210 immediately de-energizes the receptacle and sends a confirmation message to the LCU 100 and ALM module 120.

In dynamic threshold systems, if the ALM module fails (dies), the current state may become unsafe without the SmartOutlet 200 receiving a de-energize command. In these embodiments, the SmartOutlet 200 may have a watchdog functionality that only keeps ports energized as long as the SmartOutlet 200 is confident the ALM module 120 is functioning properly. The ALM module 120 sends periodic messages 122 to the SmartOutlets 200-200n that contain permission to keep ports energized. If an SmartOutlet 200-200n does not receive this permission after a predetermined amount of time, the SmartOutlet may de-energize the port.

In some embodiments, ALM load profiles can incorporate historical data, real-time load data, and future-oriented variables, including but not limited to environmental conditions, utility energy pricing and grid events, terrain, vehicle characteristics, and other dynamically evolving factors. Based on these data inputs, ALM can forecast, for example, energy flows associated with the distribution transformer; energy flows associated with the apartments in the building; when other EVs may plug in in the near-future; the battery state of charge of residents'EVs of the building in the near-future, even if those EVs are not currently plugged in; and the like.

By leveraging past performance insights alongside predictive data, the system in accordance with embodiments discussed herein influences real-time decisions, enabling optimized energy distribution and determining safe load allowances to ensure reliability and efficiency under varying conditions.

As used herein, “optimized energy distribution” includes the ability to meet the highest number of residents'energy needs by their respective departure times.

In some embodiments, the effectiveness of the ALM system improves proportionally with the accumulation of operational and environmental data over time. As the system collects and analyzes increasing volumes of data, it enhances the ability to predict, for example, energy requirements, provide cost-efficient energy distribution, maintain safe and efficient load conditions. Various artificial intelligence (AI) and machine learning (ML) methods may be used to process and train the data to provide more refined predictions over time.

In some embodiments, the ALM provides a remotely accessible dashboard of current and projected energy flows to the utility and to the operator of the EVI. The dashboard may provide, for example, aggregated reports across many ALM instances for regional forecasting.

In some embodiments, ALM can be implemented on a per-property basis and can have multiple levels of hierarchy. For example, in some embodiments, the ALM has two levels of hierarchy: the property, and the location. A property has a maximum amperes limit, and each location has a maximum amperes limit. There can be multiple locations on a single property.

In further embodiments, a large property, for example, may have multiple buildings, each with its own service entry and main breaker. Off of each of these, multiple sub-panels worth of EV charging may be installed. If the sub-panels are oversubscribed, then there may be a mismatch in hierarchy, where the property-level max amperes is not used, the location max amperes would be applied for each building.

In further embodiments, a branch circuit may be shared with more than one SmartOutlet, such that the branch circuit is oversubscribed.

As discussed above, in some embodiments, the ALM may be provided as a separate device from the LCU. Referring to the system 205 of FIG. 2, which is similar to the system 105 of FIG. 1, except the ALM 400 is separate from the LCU 100 as shown. All operations discussed above with respect to FIG. 1 remain the same and like reference numerals refer to like elements throughout. As illustrated in FIG. 2, the only difference is that the ALM 400 is separate from the LCU 100 and sends the keep alive interval (stay energized) 410 therefrom to the hardware safety switch 230 of the SmartOutlet 200.

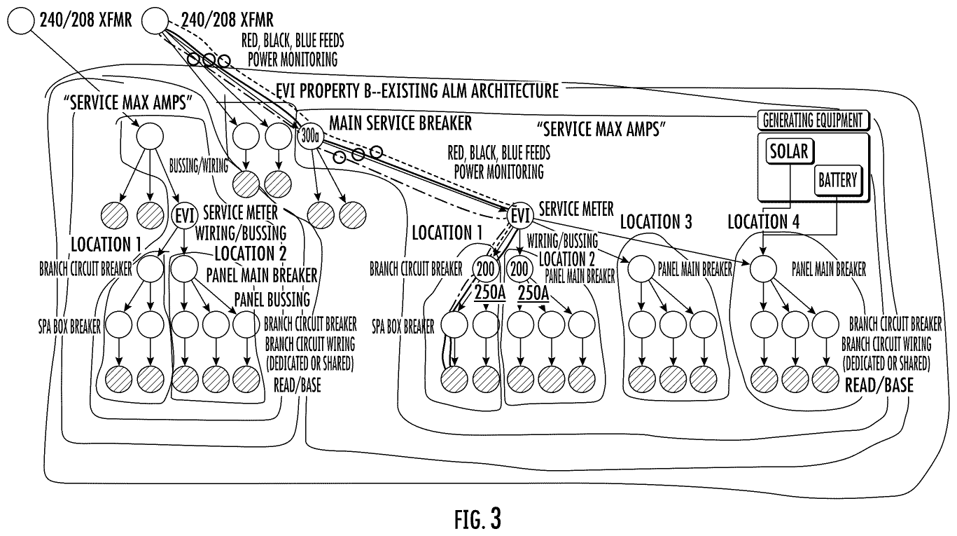

In some embodiments, the hierarchy mismatch discussed above may be addressed by an installation with a tree structure. In particular, as shown in FIG. 3, the property B includes multiple transformers (Xfmr) and a plurality of locations—Locations 1 through Location 4. FIG. 3 illustrates a drawing that an electrical system designer would ‘draw’ the system like a single line diagram is drawn and input the critical equipment ratings. This approach is beneficial because it: simultaneously accomplishes the drawing of a single-line diagram; produces a visual that is easily understood to expedite permitting and inspection; is extensible to multiple levels of hierarchy; allows for complicated utility meter assignment; and the drawing of the topology would also be responsible for assigning SmartOutlets to utility meters and parking spaces.

In some embodiments, the nodes with relevant limits (static or dynamic) are set, power monitoring locations are set, EVI loads, and external loads are set, and generating equipment is set.

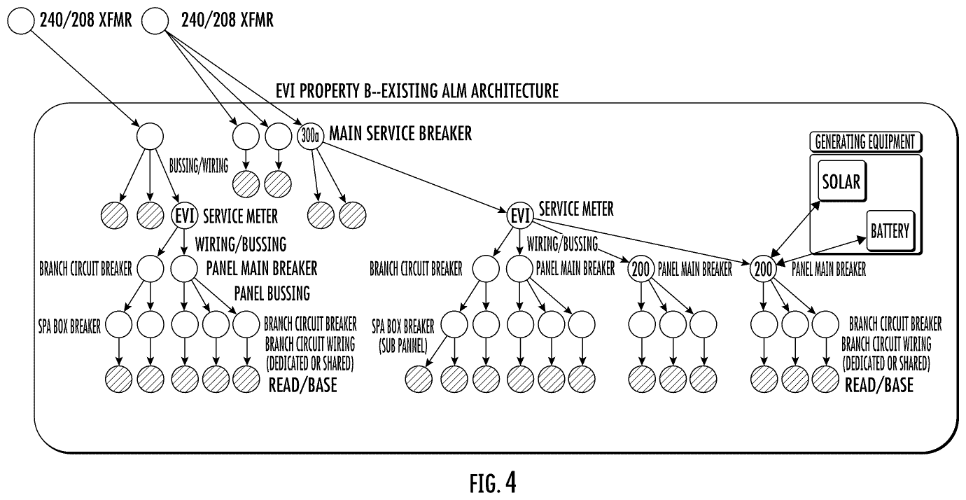

The topology line drawing of FIG. 3 can be imported by the ALM module and provide the output illustrated in FIG. 4. Thus, the ALM module imports the topology file of FIG. 3 and verifies it, for example, hash the file and the hash goes on the permit. Further details will be discussed below.

In some embodiments, for each node in FIGS. 3 and 4 with a limit, the ALM module traverses the tree to find all EVI loads beneath that node, and all power monitors related to that node. The ALM module creates a function based on each limited node that sums downstream EVI load and compares to the limit. An associated topology file can be locked, tracked, and tied to an installation in some embodiments.

Rather than drawing the entire tree as illustrated in FIG. 3, groupings of controlled/ALM limited nodes can be created, with a listing of which devices are underneath each node, for example, a location and set of SmartOutlets. Thus, embodiments are not limited to hand drawings discussed above.

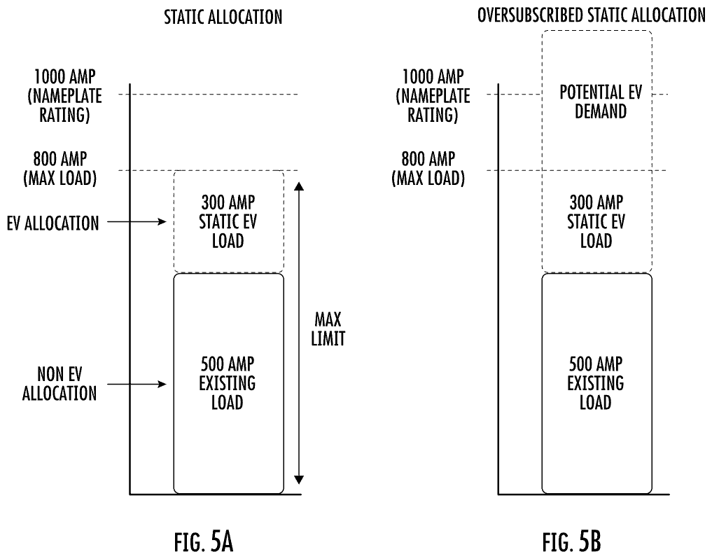

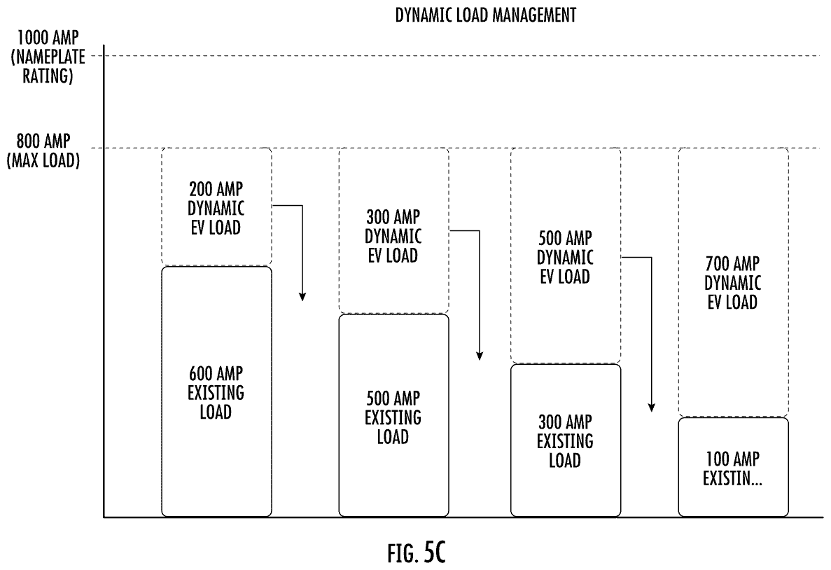

With a static limit, a charger installation may only ever draw a static limit of power (e.g. 300 A as shown in FIG. 5A). This is the same maximum power as if there were no load management, but without load management, the maximum power is limited by installing fewer chargers. With ALM, more chargers (e.g. 800 A worth of chargers) can be installed as illustrated in FIG. 5C. With a dynamic ALM limit, the EVI ports may have flows of more or less energy depending on the actual monitored load (the scenarios are illustrated in FIGS. 5A through 5C).

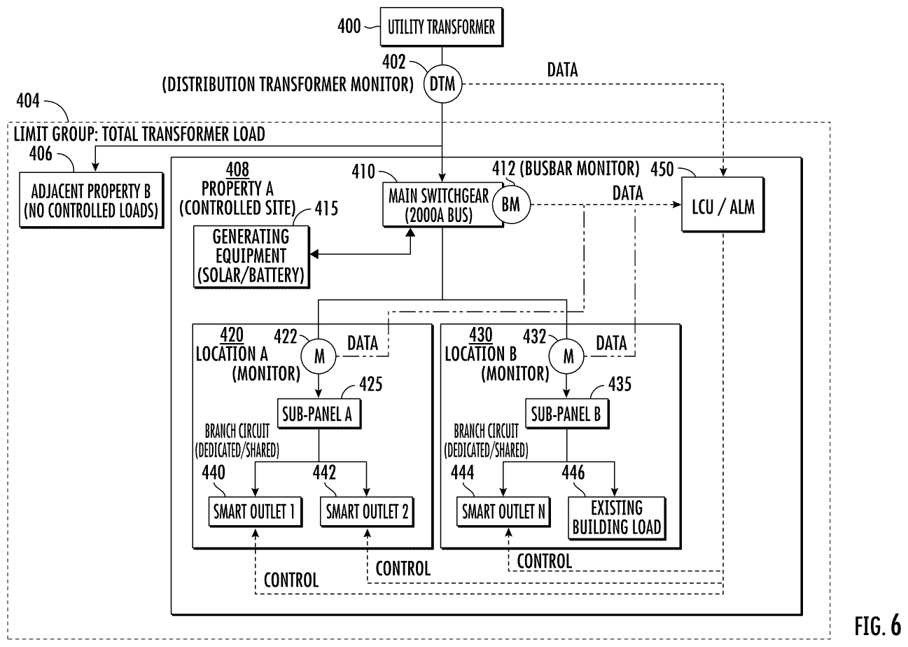

Responding dynamically to the true real-time conditions of the specific distribution transformer feeding the installation has a high potential benefit from embodiments of the present inventive concept. In particular, for installations where a transformer only serves a single property and corresponding single switchgear, then the system can just monitor that switchgear, which is generally easier to access. However, for installations where a transformer serves multiple customers/properties, in some embodiments, the sum of all loads on the transformer can be directly measured from the transformer which can be used to determine how close that transformer is to its load limit. In some embodiments according to the invention, this can be accomplished with a Distribution Transformer Monitor (DTM) 402 as illustrated in FIG. 6.

As illustrated in FIG. 6, the system includes a utility transformer 400, a DTM 402 and limit group 404 defining a total transformer load. The limit group 404 may include two properties A 408 and B 406. Property B 406 does not include any controlled loads. However, property A 408 does include a controlled site. As illustrated, property A 408 includes a main switchgear 410 that communicates with an LCU/ALM 450, generating equipment 415 and two locations A 420 and B 430. As discussed above, the LCU/ALM can be one device or separate devices without departing from the scope of the present inventive concept. Each of the locations A 420 and B 430 include a subpanel 425, 435, smart outlets 440, 442, 444 and 446, and monitors 422 and 432 as shown.

In some embodiments, if the situation calls for it, a DTM 402 can be installed on the utility transformer 400 as shown and configured to stream data to the LCU/ALM 450. It can also be configured to send data to the cloud and to the utility in some embodiments so they have visibility into the health of their asset as well.

In some embodiments, a similar measurement approach can be applied to switchgear and panels. As illustrated, in FIG. 6, a busbar monitor (BM) 412 is installed at the switchgear 410 and Monitors M 422 and 432 are installed at locations A 420 and B 430, respectively. Installing a monitor at these locations is generally easier since it does not require the utility to perform the installation with their own technicians.

In some embodiments, as shown, these meters BM and M would be installed at critical nodes, and stream data to the LCU/ALM module 450. They could also be installed during the site survey phase to carry out a load study without departing from the scope of the present inventive concept.

When it's time to change ALM limits because a transformer has been upgraded, or a service feeder has been added, and the like, then the ALM limits will be changed and communicated to the AHJ/Utility likely alongside a new permit, with a new ALM diagram and schedule as discussed above with respect to FIGS. 3 and 4.

Outside of permitted ALM limit updates, the system generally must prevent ALM limit changes. If, for example, in the current ALM scheme, an EVI admin changed the ‘location max amperes’ within the administrative user interface (UI), there is no mechanism to prevent that from overloading some equipment. In some embodiments according to the present inventive concept, the relevant ALM limits and parameters are all saved in the topology file discussed above- it's changing this file, or the association of a property to a file, which changes the ALM limits or operation. When a topology file is ready to be permitted, it is locked. The file is hashed. The hash is submitted alongside the permit.

In some embodiments, in the EVI backend, the topology file is uploaded to a property, separately, the permitted hash is entered. The backend checks that the topology file matches the hash.

In further embodiments, updating the approved hash may only be done by admins with special permissions. The LCU may also check the topology file against the hash.

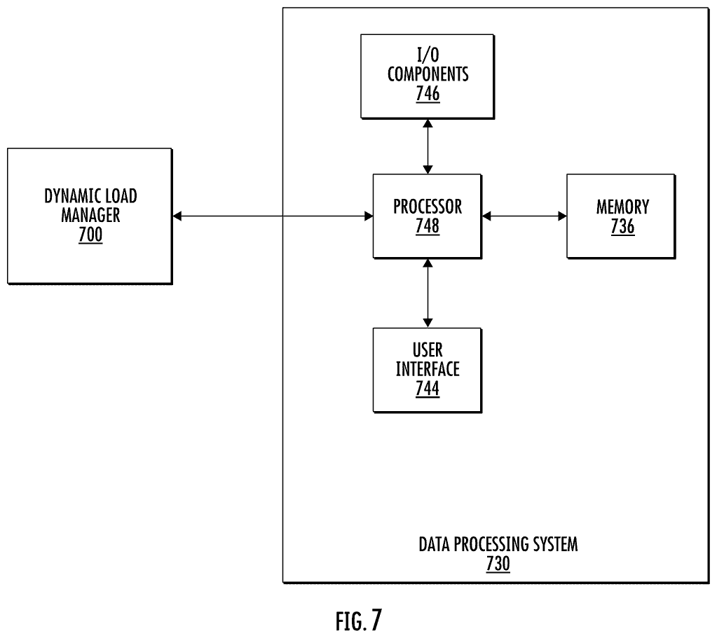

Referring now to FIG. 7, an example of a data processing system 730 suitable for use with any of the examples described above. Although the example data processing system 730 is shown as in communication with a dynamic load manager 700 in accordance with embodiments of the present inventive concept, the data processing system 730 may also be part of or in any other component of the system without departing from the scope of the present inventive concept. In some examples, the data processing system 730 can be any suitable computing device for performing operations according to the embodiments discussed herein described herein.

As illustrated, the data processing system 730 includes a processor 748 communicatively coupled to I/O components 746, a user interface 744 and a memory 736. The processor 748 can include one or more commercially available processors, embedded processors, secure processors, microprocessors, dual microprocessors, multi-core processors, other multi-processor architectures, another suitable processing device, or any combination of these. The memory 736, which can be any suitable tangible (and non-transitory) computer-readable medium such as random access memory (RAM), read-only memory (ROM), erasable and electronically programmable read-only memory (EEPROMs), or the like, embodies program components that configure operation of the data processing system 730.

I/O components 746 may be used to facilitate wired or wireless connections to devices such as one or more displays, game controllers, keyboards, mice, joysticks, cameras, buttons, speakers, microphones and/or other hardware used to input or output data. Memory 736 represents nonvolatile storage such as magnetic, optical, or other storage media included in the data processing system and/or coupled to processor 748.

The user interface 744 may include, for example, a keyboard, keypad, touchpad, voice activation circuit, display or the like and the processor 748 may execute program code or instructions stored in memory 736.

It should be appreciated that data processing system 730 may also include additional processors, additional storage, and a computer-readable medium (not shown). The processor(s) 748 may execute additional computer-executable program instructions stored in memory 736. Such processors may include a microprocessor, digital signal processor, application-specific integrated circuit, field programmable gate arrays, programmable interrupt controllers, programmable logic devices, programmable read-only memories, electronically programmable read-only memories, or other similar devices.

As briefly discussed above, some embodiments of the present inventive concept utilize various inputs to provide optimized energy delivery. There are various inputs into how the system is optimized to deliver energy. For example, for a user session (as requested in 330), how much electrical energy does a user needs by a future departure time, which also includes electricity pricing (310 and 320) now and into the near future. The system also utilizes various state information and data. For example, the Charging Manager tracks, for each user session, how much electrical energy they have already received (i.e. progress towards goals, as well as, for each user session, how much power and/or current they are currently drawing. Historical sessions (Stored Data 310) allow development of an understanding of user habits, which is important for predicting the future, for example, whether a user will come home and plug in and create an additional load in the next few hours. The system also uses externally measured loads (320) that may be received via, for example, some type of API. Finally, the system monitors (320) utility switchgear, panels, meters, and/or distribution transformers, and electric utility substation data. All of this is used to provide dynamic allocation of energy so that the system is not overloaded.

Charging devices as discussed herein may be SmartOutlets (“SmartOutlets”). The SmartOutlet handles charging sessions; receives a configured alarm or kill threshold, to set a constraint; take independent action if a threshold is exceeded and communicates with the ALM function to start a new user session (energize) and receive permission to stay energized. If no response or negative response is received, then it automatically de-energizes and may receive a comment to de-energize.

The system in accordance with embodiments discussed herein uses the above information to enact three main functions. If there is a request to change state, for example, a new user plugs in, then there is a permission to start/energize at the requested level. External inputs may cause a reduction in the constraint value, for example, if air conditioning turns on, there may be less power available. So the system checks to maintain the current state. The system also provides a predictive function, to decide whether each user's needs should be serviced now or later.

Some embodiments of the present inventive concept can use current measured load data from smart meters. Using a Control Command (118) from the Charging Manager, the SmartOutlet can adjust the load up or down, for example, to drop from charging at 16 Amperes to 5 Amperes, as opposed to turning it off entirely. In other words, embodiments discussed herein can “shed load” when necessary. Furthermore, some embodiments of the present inventive concept can allow the current to flow backwards. For example, if batteries are used in the EVs to send power back through the meters, the ALM makes sure that the aggregate power that is being sent backwards will not exceed constraints.

The aforementioned flow logic and/or methods show the functionality and operation of various services and applications described herein. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor in a computer system or other system. The machine code may be converted from the source code, etc. Other suitable types of code include compiled code, interpreted code, executable code, static code, dynamic code, object-oriented code, visual code, and the like. The examples are not limited in this context.

If embodied in hardware, each block may represent a circuit or a number of interconnected circuits to implement the specified logical function(s). A circuit can include any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Other types of multi-core processors and other multi-processor architectures may also be employed as part of the circuitry. According to some examples, circuitry may also include an application specific integrated circuit (ASIC) or a field programmable gate array (FPGA), and modules may be implemented as hardware elements of the ASIC or the FPGA. Further, embodiments may be provided in the form of a chip, chipset or package.

Although the aforementioned flow logic and/or methods each show a specific order of execution, it is understood that the order of execution may differ from that which is depicted. Also, operations shown in succession in the flowcharts may be able to be executed concurrently or with partial concurrence. Further, in some embodiments, one or more of the operations may be skipped or omitted. In addition, any number of counters, state variables, warning semaphores, or messages might be added to the logical flows or methods described herein, for purposes of enhanced utility, accounting, performance measurement, or providing troubleshooting aids, etc. It is understood that all such variations are within the scope of the present disclosure. Moreover, not all operations illustrated in a flow logic or method may be required for a novel implementation.

Where any operation or component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages. Software components are stored in a memory and are executable by a processor. In this respect, the term “executable” means a program file that is in a form that can ultimately be run by a processor. Examples of executable programs may be, for example, a compiled program that can be translated into machine code in a format that can be loaded into a random access portion of a memory and run by a processor, source code that may be expressed in proper format such as object code that is capable of being loaded into a random access portion of a memory and executed by a processor, or source code that may be interpreted by another executable program to generate instructions in a random access portion of a memory to be executed by a processor, etc. An executable program may be stored in any portion or component of a memory. In the context of the present disclosure, a “computer-readable medium” can be any medium (e.g., memory) that can contain, store, or maintain the logic or application described herein for use by or in connection with the instruction execution system.

A memory is defined herein as an article of manufacture and including volatile and/or non-volatile memory, removable and/or non-removable memory, erasable and/or non-erasable memory, writeable and/or re-writeable memory, and so forth. Volatile components are those that do not retain data values upon loss of power. Nonvolatile components are those that retain data upon a loss of power. Thus, a memory may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

The devices described herein may include multiple processors and multiple memories that operate in parallel processing circuits, respectively. In such a case, a local interface, such as a communication bus, may facilitate communication between any two of the multiple processors, between any processor and any of the memories, or between any two of the memories, etc. A local interface may include additional systems designed to coordinate this communication, including, for example, performing load balancing. A processor may be of electrical or of some other available construction.

It should be emphasized that the above-described embodiments of the present disclosure are merely possible examples of implementations set forth for a clear understanding of the principles of the disclosure. It is, of course, not possible to describe every conceivable combination of components and/or methodologies, but one of ordinary skill in the art may recognize that many further combinations and permutations are possible. That is, many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A dynamic load management system for charging electric devices, the system comprising:
one or more smart outlets including one or more charging ports therein;
a local control unit (LCU) coupled to the one or more smart outlets that includes a charging manager and receives stored data, monitored data and user input, wherein the charging manager processes the received stored data, monitored data and user input to generate a control command that is used to energize a charging port of the one or more charging ports or to change energy flow of a session; and
an automatic load management (ALM) module in communication with the LCU and the one or more smart outlets, the ALM receiving real-time load data and load requests from the charging manager and providing a status to the charging manager to enable dynamic allocation of resources to the one or more smart outlets,
wherein the one or more smart outlets include a hardware safety switch that energizes or deenergizes responsive to signals from the LCU and/or the ALM.

2. The system of claim 1, wherein the one or more smart outlets further include:
metrology and sensors that measure current flow through an associated charging port and provide load data and sensor readings to the charging manager; and
a session controller that energizes and de-energizes charging ports responsive to the control command.

3. The system of claim 2, wherein the one or more smart outlets shed load such that current may be apportioned at intervals between a fully off state and a fully on state by reducing current allocation without fully de-energizing a charging port.

4. The system of claim 1, wherein the ALM is one of separate and distinct from the LCU and integrated with the LCU into a single device.

5. The system of claim 1, wherein the electric device comprises an electric vehicle.

6. The system of claim 5, wherein the system further comprises at least one external power monitor configured to measure a load on at least one of a distribution transformer, switchgear, panel, or feeder and provide the measured load to the LCU for use in allocating resources to the one or more smart outlets.

7. The system of claim 6, wherein the ALM further:
receives real-time load measurements from the at least one external power monitor and from the smart outlets;
determines whether a proposed charging state satisfies all hierarchical limits;
transmits energize and de-energize permissions to the smart outlets; and
periodically transmits keep-alive authorization messages to the one or more smart outlets such that failure to receive the keep-alive authorization causes the smart outlet to automatically de-energize the one or more charging ports.

8. The system of claim 1, wherein the ALM permits bi-directional power flow from the electric device while ensuring reverse aggregate current does not exceed a predetermined threshold.

9. The system of claim 1, wherein the hardware safety switch immediately opens when a measured current exceeds a kill threshold independent of software execution.

10. The system of claim 1, further comprising a distribution transformer monitor mounted to a utility transformer and streaming load data to the ALM.

11. The system of claim 1, wherein load limits are enforced at property, building, and sub-panel hierarchy levels.

12. The system of claim 1, wherein current is adjusted based on utility pricing and environmental conditions.

13. The system of claim 1, wherein the one or more smart outlets reduce or increase energy flow in response to control commands from the LCU.

14. A method of dynamically managing electric vehicle charging loads, comprising:
receiving a charging session request for at least one charging port;
receiving real-time electrical load measurements from at least one external power monitor and from one or more smart outlets;
evaluating a system topology file defining hierarchical static and dynamic load limits for electrical infrastructure nodes;
determining whether the charging session request satisfies all load limits defined in the topology file;
transmitting an energize command and a kill threshold to one or more smart outlets when the charging session request is safe;
periodically transmitting keep-alive messages to the one or more smart outlets; and
causing the smart outlet to de-energize the at least one charging port when the keep-alive messages are not received within a predetermined time interval.

15. The method of claim 14, further comprising forecasting future load using historical session data and user departure times.

16. The method of claim 14, further comprising dynamically reducing current to an active session when external loads increase.

17. The method of claim 14, further comprising reverting to a predefined static safe load when real-time monitoring data becomes unavailable.

18. The method of claim 14, further comprising generating a dashboard showing current and forecasted transformer loading.

19. A non-transitory computer-readable medium storing instructions for dynamically managing electrical vehicle charging loads that, when executed by one or more processors, cause the processors to:
receive a charging session request for at least one charging port;
receive real-time electrical load measurements from at least one external power monitor and from one or more smart outlets;
evaluate a system topology file defining hierarchical static and dynamic load limits for electrical infrastructure nodes;
determine whether the charging session request satisfies all load limits defined in the topology file;
transmit an energize command and a kill threshold to one or more smart outlets when the charging session request is safe;
periodically transmit keep-alive messages to the one or more smart outlets; and
cause the smart outlet to de-energize the at least one charging port when the keep-alive messages are not received within a predetermined time interval.

20. The non-transitory computer-readable medium of claim 19, wherein the instructions further dynamically reduce current to an active session when external loads increase.
